(19) United States
(12) Patent Application Publication
(10) Pub. No.: US 2010/0247823 A1
(43) Pub. Date: Sep. 30, 2010

(54) Molten Material and Package Combination and Method for Packaging Hot Melt Material

(75) Inventor: Douglas E. Howell, Oak Park, IL (US)

Correspondence Address: BANNER & WITCOFF, LTD., TEN SOUTH WACKER DRIVE, SUITE 3000, CHICAGO, IL, 60606, US

(73) Assignee: Daubert Chemical Company, Inc., Chicago, IL (US)

(21) Appl. No.: 12/411,540

(22) Filed: Mar. 26, 2009

(51) Int. Cl. B32B 1/06; B32B 15/08; B32B 37/00; B65B 3/04

(52) U.S. Cl. 428/35.3; 428/35.2; 156/145; 53/469

(57) ABSTRACT

Disclosed herein is a method comprising filling a retort pouch with molten material, folding the top of the pouch over near or at the molten material line to expel air from the pouch, and sealing the pouch. Also disclosed herein is a molten material and package combination.

### FIELD OF THE INVENTION

This disclosure relates to a molten material and package combination, and a method for packaging hot melt material.

### BACKGROUND OF THE INVENTION

A pouch or bag having a polyethylene inner heat seal layer, and having an aluminum foil layer have been typically used in packaging for hot melt or molten material, such as hot melt polyurethane (having, e.g., a temperature of about 250° F.). Such hot melt material is typically poured into a vertically supported pouch (laminated foil and heat seal film). In a conventional method, the air in the pouch is typically purged out of the pouch with dry nitrogen gas to eliminate moisture. The dry nitrogen gas also expands the pouch. The pouch is then sealed, and allowed to cool to the solid phase with the pouch in the vertical position. It is believed that the “vertical” cooling step is utilized to yield a uniform shape and prevent pouch material from folding and becoming embedded within the molten mass. Such vertical cooling of a 2 pound package of hot melt polyurethane from about 250° F. to ambient temperature of about 68° F. typically takes about 8 hours. Significant degradation of molten material due to cross-linking of reactive polymer can increase with long cooling times exceeding more than about 3 hours.

FIG. 1 illustrates an example of a pouch 3 filled with gas and hot melt material, wherein the gas has expanded the pouch in the upper volume 4 of pouch 3, and the hot melt material is in the lower volume 5 of pouch 3. After cooling, a pouch corner may be clipped, the gas in the pouch expelled (so that the pouch is less fragile, less prone to pop, and takes up less space), and the corner resealed. FIG. 2 illustrates an example of a pouch 3 wherein a pouch corner has been clipped, the gas that had been kept in upper volume 4 has been expelled, and pouch 3 resealed at corner 6. Conventional methods for packaging molten material can be time-consuming and require special purging equipment.

### BRIEF SUMMARY OF THE INVENTION

Disclosed herein is a method for packaging molten material that eliminates the need for purging of air with an inert gas. The disclosed method can be used in place of conventional approaches.

In one aspect, the method comprises filling a retort pouch or bag, folding the top of the pouch over near or at the molten material line to expel air from the pouch, and then sealing the pouch.

In another aspect, the method comprises laying a side of the filled and sealed pouch on a metal sheet, the side being substantially transverse to the bottom of the pouch.

In another aspect, a molten material and package combination is formed by filling a retort pouch from the top of the pouch with molten material, the pouch having a bottom opposite the top of the pouch, folding the top of the pouch over near a molten material line in the pouch to expel air from the pouch, and sealing the pouch.

### BRIEF DESCRIPTION OF THE DRAWINGS

Non-limiting embodiments will now be described with reference to the accompanying drawings.

FIG. 1 illustrates an example of a pouch filled with gas and hot melt material in accordance with a conventional method.

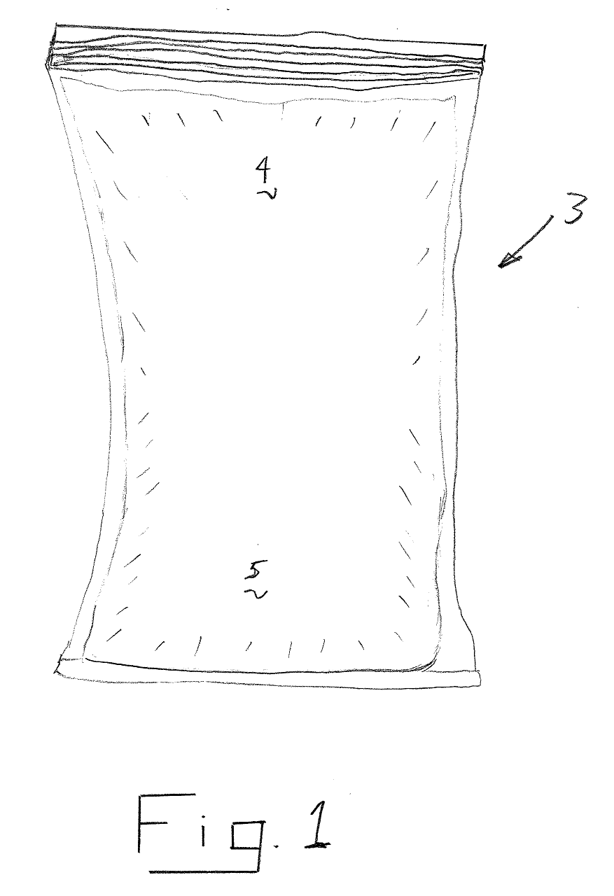

FIG. 2 illustrates an example of a pouch wherein a corner has been clipped, the gas in the pouch expelled, and the corner resealed in accordance with a conventional method.

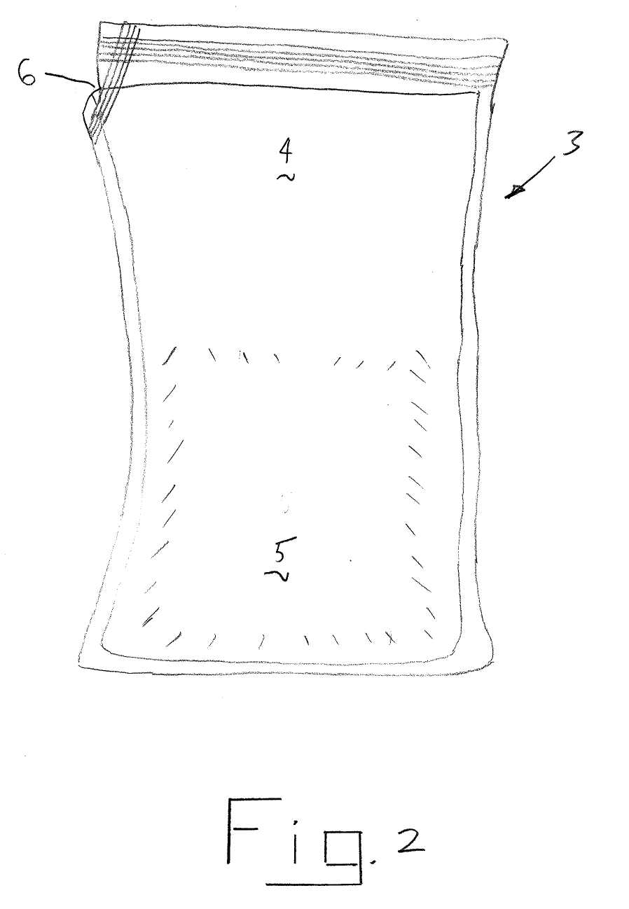

FIG. 3 illustrates a front perspective view of a pouch being filled with molten material in accordance with an aspect disclosed herein.

FIG. 4 illustrates a front perspective view of the top of a pouch being folded over in accordance with an aspect disclosed herein.

FIG. 5 illustrates a front perspective view of the top of a pouch being sealed in accordance with an aspect disclosed herein.

FIG. 6 illustrates a perspective view of the multiple pouches being placed onto a metal sheet in accordance with an aspect disclosed herein.

### DETAILED DESCRIPTION OF EMBODIMENTS OF THE INVENTION

It will be appreciated by those skilled in the art, given the benefit of the following description of certain exemplary embodiments of the method and packaging disclosed here, that at least certain embodiments of the invention have improved or alternative production aspects. These and other aspects, features and advantages of the invention or of certain embodiments of the invention will be further understood by those skilled in the art from the following description of exemplary embodiments.

The method disclosed herein can reduce or eliminate drawbacks of conventional approaches. The method disclosed herein can provide for more efficient packaging of molten material. The method disclosed herein eliminates the need to purge air from the packaging with an inert gas, and thus eliminates the need for and operation of purging equipment. The method can be useful for packaging any molten material, e.g., molten material having a melting point between about 150 to 300 degrees Fahrenheit. The method can be to package molten material in a suitably sized package, e.g., about a 2 to 50 pound package of molten material. In a preferred embodiment, the molten material is packaged in a 2 to 10 pound package of molten material. A more preferred embodiment can be 2 to 5 pound package of molten material, or about 2 pounds of molten material.

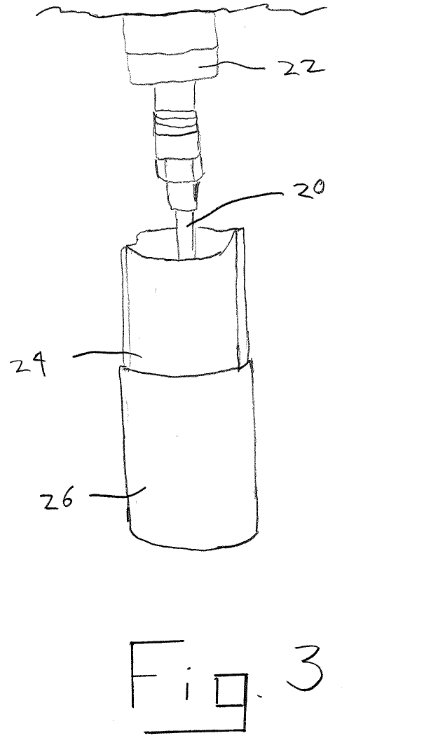

In accordance with an example of the disclosed method, a retort pouch or bag having an inner heat seal layer and a foil layer can be used. The inner heat seal layer can comprise any suitable material, including e.g. polypropylene and polyethylene. In a preferred embodiment, the inner heat seal can comprise a high melting polypropylene. The foil layer can comprise an aluminum foil. As shown in FIG. 3, molten material 20, such as hot melt polyurethane (having, e.g., a temperature of about 250° F.), can be poured from a filling apparatus 22 (partially shown) into a vertically supported pouch 24. Pouch 24 can be vertically supported by an open container or can 26. Pouch 24 can comprise a laminated foil and heat seal film.

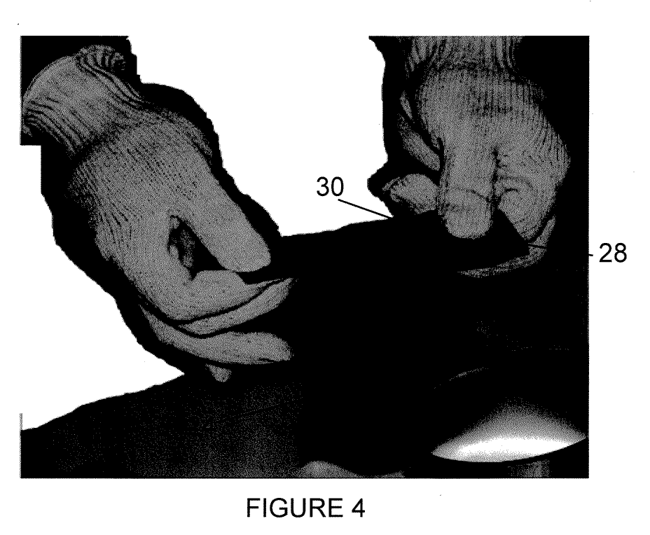

As shown in FIG. 4, the top 28 of pouch 24 can be folded over near or at the molten material line 30, i.e., the liquid line, to “burp” or expel most of the air.

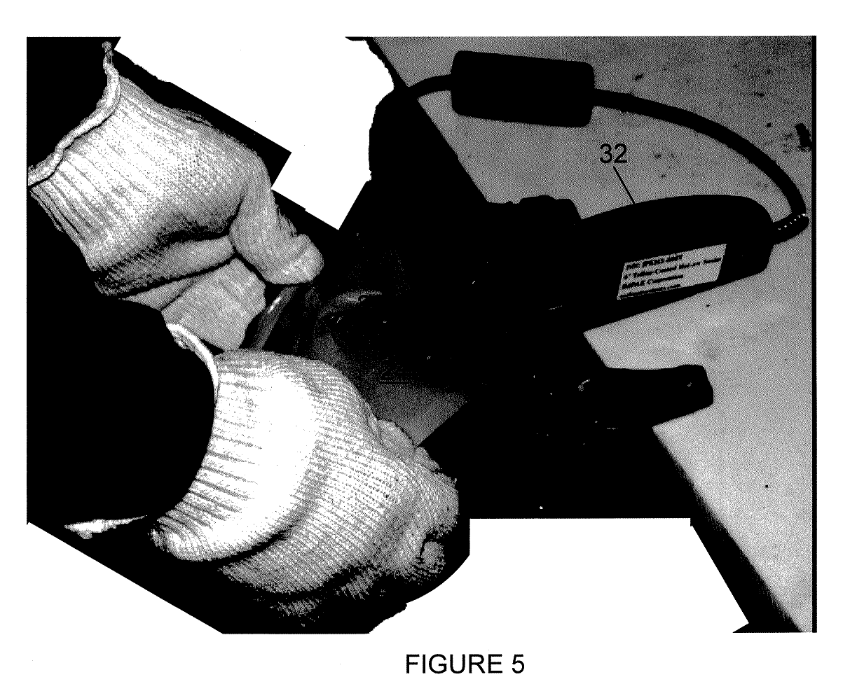

As show in FIG. 5, top 28 of pouch 24 can then be sealed with a sealing device 32.

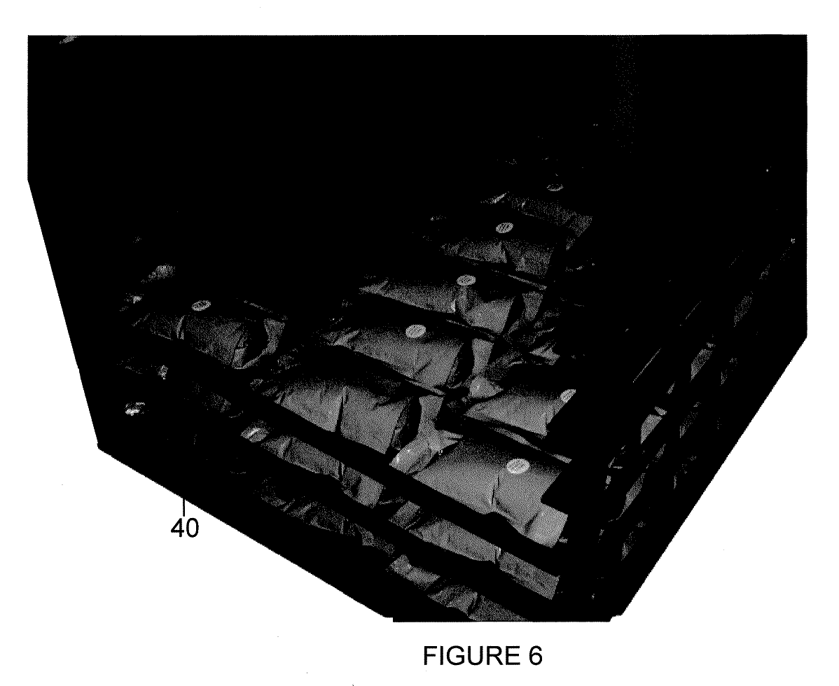

As shown in FIG. 6, each sealed pouch 24 can then be laid flat to cool. The result of the above steps creates a pillow 34 of liquid, with the liquid in contact with nearly all the interior pouch surface. Pillow 34 can cool to the solid phase without significant wrinkles in the pouch. The pouch can be placed on a flat metal sheet 36 to allow for quicker cooling. More specifically, the pouch can be laid onto sheet 36 on a side 40 of pouch 24 that is substantially transverse to bottom 38 of pouch 24. Such cooling of a 2 pound package of hot melt polyurethane from about 250° F. to ambient temperature of about 68° F. typically no more than about 3 hours.

It has been found that in following the above steps there is not enough moisture present in the minimal airspace of the pouch to form undesirable moisture induced skin on the material. The flat shape allows multiple pouches to be placed inside different cartons to create many package configurations. This method eliminates the step of purging air with an inert gas, as well as time-consuming steps, after cooling, of clipping a corner of the pouch, evacuating the inert gas, and resealing the pouch.

Following the method disclosed herein results in a packaged molten material that does not have significant wrinkling and in which no portion of the packaging is significantly embedded in the packaged material. After the packaged material is cooled to the solid phase, such as cooling at ambient temperature, the packaged material can be easily transported to a point of use. At the point of use, the packaging can be removed from the packaged material, and the packaged material can be heated in a suitable apparatus to a molten state and applied in accordance with its intended use. Such intended use can be an adhesive, e.g., a hot melt adhesive, to bond similar or disparate structures and/or materials together. The packaging can be readily removed from the packaged material since, as noted above, it does not become significantly embedded in the packaged material.

The methods disclosed above in connection with the present invention are hereby incorporated herein with respect to another aspect of the present invention, i.e., a molten material and package combination 60, shown in FIG. 6. Thus, an aspect of the present invention is a molten material and package combination 60 that is formed by filling a retort pouch 24 from top 28 of the pouch, as described above, with molten material 20, the pouch 24 having a bottom 38 opposite top 28 of the pouch, folding top 28 of the pouch over near a molten material line in the pouch to expel air from the pouch, and sealing the pouch. Thus, a pillow 34 of molten material 20 is formed within the sealed pouch 24. The resulting molten material and package combination 60, i.e., the sealed pouch 24 and molten material 20 contained therein, can be cooled by laying the sealed pouch on a side that is substantially transverse to the bottom of the sealed pouch, wherein the side of the sealed pouch is laid onto a metal sheet, as described above. In the molten material and package combination 60, the pouch can comprise a foil layer and an inner heat seal layer. In the molten material and package combination 60, the inner heat seal layer can comprise a material selected from high melting polyethylene, high melting polypropylene, and combinations thereof. Because there is little or no air within the molten material and package combination 60 after cooling, there is no need clip or otherwise create an opening in molten material and package combination 60 to purge a gas after cooling. Thus, material and package combination 60 is devoid of gas within the sealed pouch 24, and is devoid of a clipped corner or other opening in pouch 24 to purge a gas after cooling.

Those of skill in the art will recognize that any or all the steps described above can be performed with apparatus and/or devices that are automated, and which can be facilitated with computer control, and are thus included within the scope of the present invention.

It will be apparent to persons skilled in the art that various modifications and alterations to the preferred embodiments mentioned above may be made without departing from the underlying concept of the inventions. All such modifications and alterations are included within the scope of the present invention.

What is claimed is:

1. A method comprising:
filling a retort pouch from the top of the pouch with molten material, the pouch having a bottom opposite the top of the pouch,
folding the top of the pouch over near a molten material line in the pouch to expel air from the pouch, and
sealing the pouch.

2. The method of claim 1, further comprising cooling of the sealed pouch by laying the sealed pouch on a side that is substantially transverse to the bottom of the sealed pouch.

3. The method of claim 2, wherein the side of the sealed pouch is laid onto a metal sheet.

4. The method of claim 1, wherein the pouch comprises a foil layer and an inner heat seal layer.

5. The method of claim 4, wherein the inner heat seal layer comprises a material selected from high melting polyethylene, high melting polypropylene, and combinations thereof.

6. The method of claim 4, wherein the inner hear seal layer comprises high melting polypropylene.

7. The method of claim 4, wherein the foil layer comprises aluminum foil.

8. The method of claim 1, wherein the molten material comprises a hot melt adhesive.

9. The method of claim 1, wherein the molten material comprises polyurethane.

10. The method of claim 1, wherein the molten material has a melting point between about 150 to 300 degrees Fahrenheit.

11. The method of claim 1, wherein the molten material has melting point of about 250 degrees Fahrenheit.

12. The method of claim 1, wherein the folding the top of the pouch occurs at the molten material line.

13. The method of claim 1, wherein the pouch is adapted to hold about 2 to 50 pounds of molten material.

14. The method of claim 1, wherein the pouch is adapted to hold about 2 to 10 pounds of molten material.

15. The method of claim 1, wherein the pouch is adapted to hold about 2 to 5 pounds of molten material.

16. The method of claim 1, wherein the pouch is adapted to hold about 2 pounds of molten material.

17. A molten material and package combination that is formed by filling a retort pouch from the top of the pouch with molten material, the pouch having a bottom opposite the top of the pouch, folding the top of the pouch over near a molten material line in the pouch to expel air from the pouch, and sealing the pouch.

18. The molten material and package combination of claim 17, wherein the sealed pouch is cooled by laying the sealed pouch on a side that is substantially transverse to the bottom of the sealed pouch, wherein the side of the sealed pouch is laid onto a metal sheet.

19. The molten material and package combination of claim 17, wherein the pouch comprises a foil layer and an inner heat seal layer.

20. The molten material and package combination of claim 19, wherein the inner heat seal layer comprises a material selected from high melting polyethylene, high melting polypropylene, and combinations thereof.
